(19) United States
(12) Patent Application Publication
(10) Pub. No.: US 2026/0295922 A1
(43) Pub. Date: Oct. 1, 2026

(54) PREFORM COOLING TUBE

(71) Applicant: AMCOR RIGID PACKAGING USA, LLC, Ann Arbor, MI (US)

(72) Inventors: Milton DOMACIANO, João Pessoa (BR); Ivan Vicente ASSENÇO, Jundiaí (BR); Luke A. MAST, Brooklyn, MI (US); Michael T. LANE, Brooklyn, MI (US); Dan WITHAM, Sylvania, OH (US); Mariano Andres HERRERA MENGHI, Pembroke Pines, FL (US); Jonathan MCGURK, Toledo, OH (US)

(21) Appl. No.: 19/478,561

(22) PCT Filed: May 3, 2023
(86) PCT No.: PCT/US2023/020791

§ 371 Date: Oct. 24, 2025

(51) Int. Cl. B29C 49/64; B29C 49/06; B29L 31/00

(52) U.S. Cl. CPC B29C 49/6435; B29C 49/06; B29L 2031/712

(57) ABSTRACT

A cooling tube for cooling a preform configured to be injection blow-molded into a container. The cooling tube includes a first end and a second end opposite to the first end. A receptacle is defined within the cooling tube and is configured to receive the preform therein. A first opening of the receptacle is at the first end. A groove extends helically around an exterior of the cooling tube. The groove progressively increases in depth as the groove extends towards the second end. The groove is configured to receive a coolant therein.

### FIELD

The present disclosure relates to a preform cooling tube configured to cool a container preform.

### BACKGROUND

This section provides background information related to the present disclosure, which is not necessarily prior art.

As a result of environmental and other concerns, plastic containers, more specifically polyester and even more specifically polyethylene terephthalate (PET) containers, are now being used more than ever to package numerous commodities previously supplied in glass containers. Manufacturers and fillers, as well as consumers, have recognized that PET containers are lightweight, inexpensive, recyclable and manufacturable in large quantities.

### SUMMARY

This section provides a general summary of the disclosure, and is not a comprehensive disclosure of its full scope or all of its features.

The present disclosure includes a cooling tube for cooling a preform configured to be injection blow-molded into a container. The cooling tube includes a first end and a second end opposite to the first end. A receptacle within the cooling tube is configured to receive the preform therein. The receptacle includes an inner surface shaped to correspond to a preform shape of the preform. A first opening of the receptacle is at the first end. A second opening of the receptacle is opposite to the first opening. A channel extends from the second opening to the second end of the cooling tube. A groove extends helically around an exterior of the cooling tube. The groove progressively increases in both depth and volume as the groove extends towards the second end. The groove is configured to receive a coolant therein. A base surface of the groove can be sloped to match the inner surface of the receptacle. A pointed edge is at an inlet of groove. The pointed edge is configured to reduce turbulence of the coolant as the coolant enters the groove. An outlet is defined at an end of the groove, the outlet extending from the groove to the second end.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a side view of an exemplary cooling tube in accordance with the present disclosure;

FIG. 2 illustrates area 2 of FIG. 1;

FIG. 3 is a perspective view of the cooling tube of FIG. 1;

FIG. 4 is a cross-sectional view taken along line 4-4 of FIG. 3;

FIG. 5 is a cross-sectional view of another exemplary cooling tube in accordance with the present disclosure;

FIG. 6 is a side view of exemplary cooling tube channels in accordance with the present disclosure;

FIG. 7 is a perspective view of an exemplary sleeve configured to receive the cooling tube therein;

FIG. 8 is a cross-sectional view of another exemplary cooling tube in accordance with the present disclosure;

FIG. 9 is a cross-sectional view of an additional exemplary cooling tube in accordance with the present disclosure;

FIG. 10 is a cross-sectional view of a further exemplary cooling tube in accordance with the present disclosure;

FIG. 11 is a cross-sectional view of an additional configuration for a cooling tube in accordance with the present disclosure; and

FIG. 12 is a cross-sectional view of still another exemplary cooling tube in accordance with the present disclosure.

Corresponding reference numerals indicate corresponding parts throughout the several views of the drawings.

### DETAILED DESCRIPTION

Example embodiments will now be described more fully with reference to the accompanying drawings.

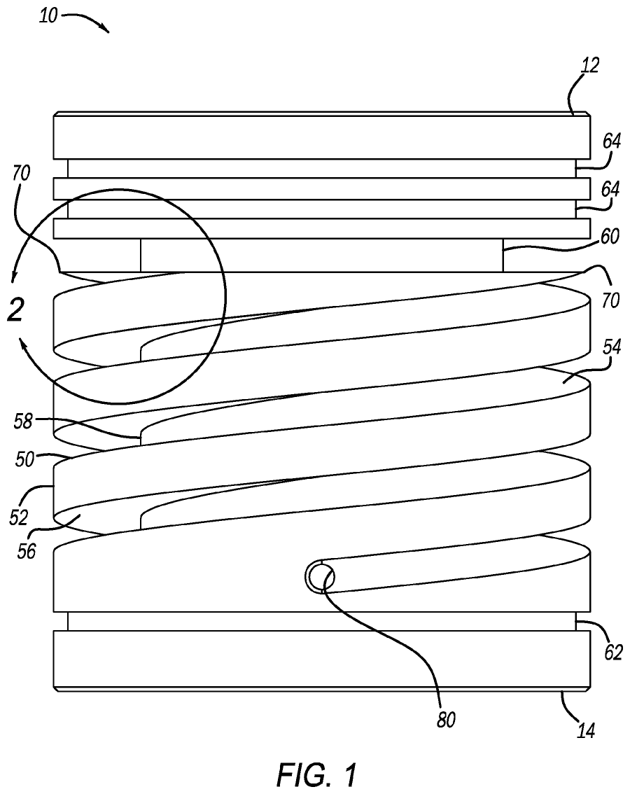

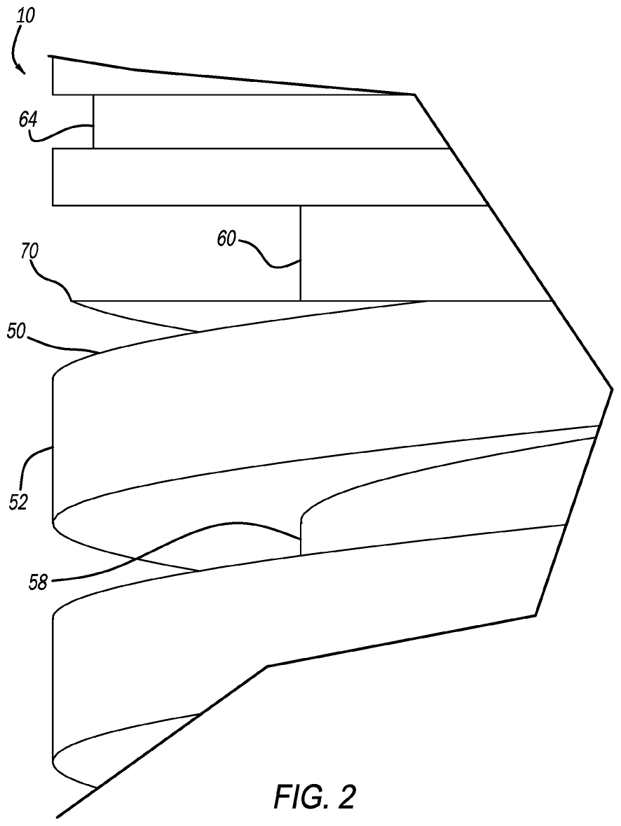

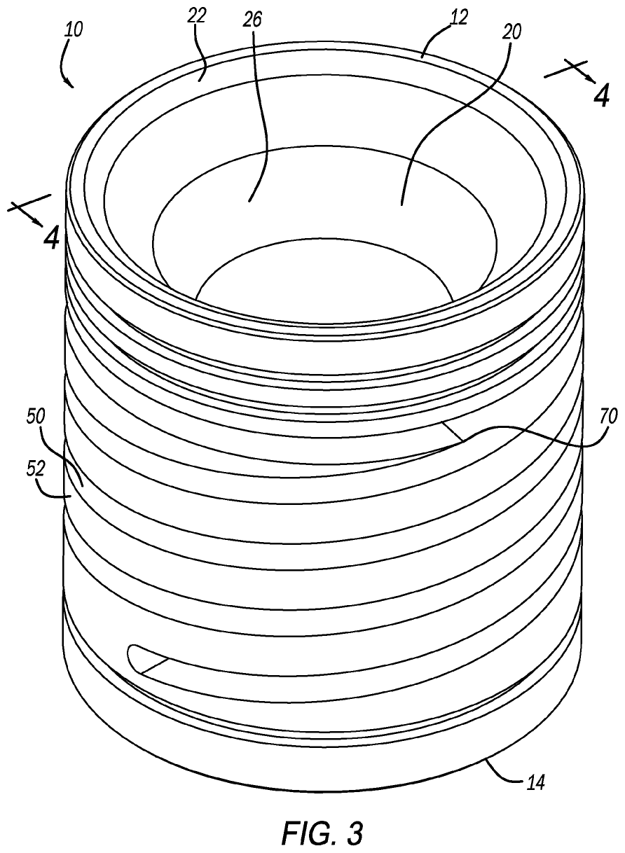

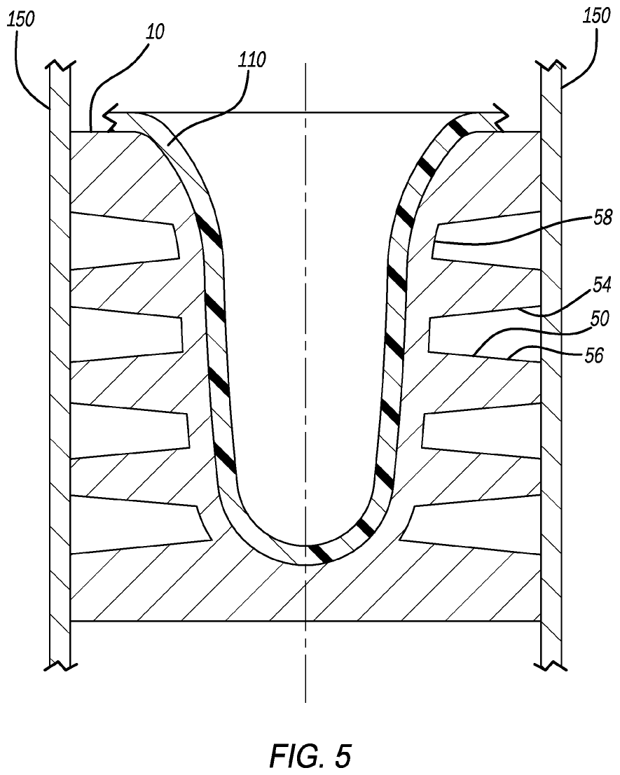

FIGS. 1-4 illustrate an exemplary preform cooling tube 10 in accordance with the present disclosure for cooling an exemplary preform 110 (FIG. 5). The preform cooling tube 10 is configured to cool the preform 110 during a process for forming a container by injection blow molding. The preform cooling tube 10 is configured to cool any suitable preform for forming any suitable container. For example, the cooling tube 10 is configured to cool preforms configured to form standard and wide-mouth containers, such as containers for food, sauces, fruits, water, juice, carbonated soda containers, etc., for example. Such containers are molded from preforms having various degrees of taper in the body of the preform. Preforms for molding larger finish wide mouth containers typically have the highest degree of taper. The cooling tube 10 may be made of any suitable material, such as aircraft aluminum 8090, T83, T86, or T651, for example.

The cooling tube 10 is configured to cool polymeric preforms after they are injection molded. Injection molded preforms are used in 2-step blow molding where the preform is first injection molded in an injection molding machine, then the preform is later formed into a final bottle shape in a blow molding machine. Cooling of the preform is important to improve production cycle time; the faster the preform is cooled, the faster the next batch of preforms can be injected. After injection molding, the hot preform is transferred with a robotic arm (“end of arm tooling”) into the cooling tube 10 where the preform contacts the metal of the tube. The cooling tube 10 is configured for use in one-step blow molding as well.

The preferred molding process is two-step stretch blow molding, but any suitable process can be used where improved preform cooling is desired, such as extrusion blow molding (EMB) or injection stretch blow molding (ISBM). Two-step stretch blow molding includes using a pre-made injection molded preform that is optimized for the final blow molded container. The injection molded preform is reheated and placed in a blow mold where it is stretched lengthwise (axial stretch) to about twice its original length. Compressed air is then blown into the stretched preform to expand to the blow mold (radial stretch) forming the final shape of the container.

The cooling tube 10 may be generally configured as a canister for receiving the preform 110 therein for cooling. The cooling tube 10 is seated within a sleeve 150 during the cooling process. The preform may be made of any suitable material. For example, the preform 110 may be made of polyethylene terephthalate (PET or PETE), or any other suitable thermoplastic including polyethylene, polypropylene, or bio-based materials. DAK Americas HS Ti818 is an example of a suitable PET resin. PET is a clear, strong, and lightweight plastic that is widely used for packaging foods and beverages, convenience-sized soft drinks, juices, and water. It is also popular for packaging salad dressings, peanut butter, cooking oils, mouthwash, shampoo, soaps, cleaners, and the like. The basic building blocks of PET are ethylene glycol and terephthalic acid, which are combined to form a polymer chain. The resulting spaghetti-like strands of PET are extruded, quickly cooled, and cut into small pellets. The resin pellets are then heated to a molten liquid that can be easily extruded or molded into items of practically any shape. PET is completely recyclable, and is the most recycled plastic in the U.S and worldwide. PET can be commercially recycled by thorough washing and re-melting, or by chemically breaking it down to its component materials to make new PET resin. Almost every municipal recycling program in North America and Europe accepts PET containers. Products commonly made from recycled PET include new PET bottles and jars. Recycled PET is commonly referred to as rPET and PCR.

Post consumer recycled (PCR) resin is the recycled product of waste created by consumers. Post industrial regrind (PIR) is any closed-loop/recaptured scrap resin directly resulting from the manufacturing process such as the scrap created by the manufacturing process of bottles and closures that is solely recaptured and reworked within the manufacturing plant such as hot-runners, flash, moils, and tails from the molding or extruding process that has gone through at least one molding or extrusion process and is subsequently grounded and reintroduced back into the manufacturing process. Since PCR/PIR regrind material has gone through an initial heat and molding process, it cannot be considered “virgin” material. The physical, chemical and flow properties can differ slightly from virgin material, therefore PCR and PIR is not generally used exclusively to make new bottles or parts, but it is blended with virgin PET. Before PCR and PIR plastic is turned into resin, the materials are sent through a proprietary process and cleaning to produce plastic resin pellets. Verdeco food-grade rPET is an example of a suitable resin.

The cooling tube 10 is generally circular, and may be configured as a canister. The cooling tube 10 includes an upper (or top) end 12 and a lower (or bottom) end 14, which is opposite to the upper end 12. The cooling tube 10 defines a receptacle 20 between the upper end 12 and the lower end 14. At the upper end 12 is a first opening 22 of the receptacle 20. Recessed inward from the second end 14 is a second opening 24 of the receptacle 20. The first opening 22 is wider than the second opening 24. The receptacle 20 includes an inner surface 26, which is sloped or otherwise shaped to mirror the shape of the preform. Thus, from the first opening 22 the inner surface 26 of the receptacle 20 generally tapers inward to the second opening 24. The cooling tube 10 defines a channel 30 extending from the second opening 24 to the second end 14 of the cooling tube 10.

The cooling tube 10 defines a plurality of cooling grooves or channels 50 at an exterior of the cooling tube 10. The cooling grooves 50 generally spiral around the receptacle 20. The cooling grooves 50 are recessed within an outer surface 52 of the cooling tube 10. The cooling grooves 50 may be formed in any suitable manner. For example, the cooling grooves 50 may be formed by 3D printing of the cooling tube 10. The cooling grooves 50 may also be formed by any suitable manufacturing process that incorporates high-powered lasers to melt metal powder, such as, but not limited to, the following: direct metal laser sintering (DMLS); selective laser melting (SLM); or direct metal laser melting (DMLM). The cooling tube 10 may be formed by any other material suitable for machining or DMLS, for example.

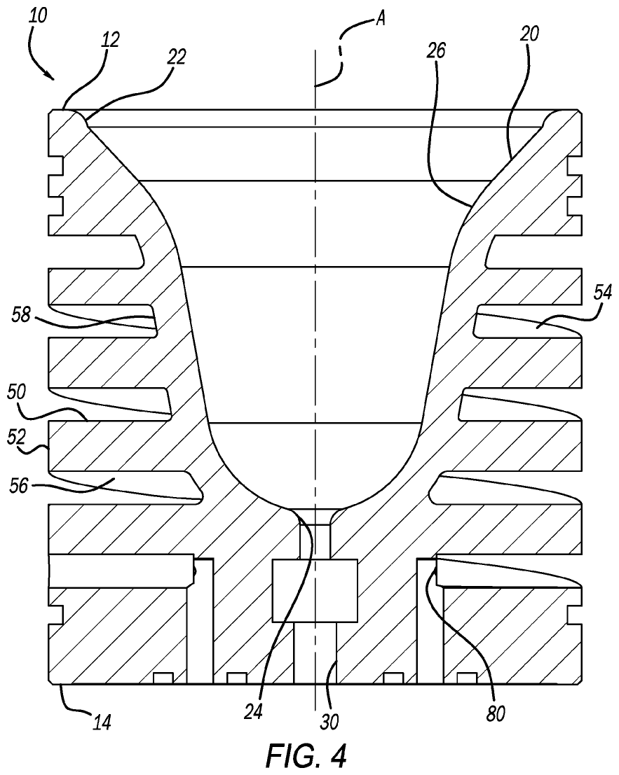

The cooling grooves 50 are defined by an upper ramped surface 54 and a lower ramped surface 56. In one embodiment, the ramped surfaces 54 and 56 can be parallel to each other and horizontal to the longitudinal axis A (FIG. 4). Thus, in FIG. 4, the upper ramped surface 54 and the lower ramped surface 56 extend parallel to each other and perpendicular to the longitudinal axis A. In another embodiment, the ramped surfaces 54 and 56 can be angled away from each other and not parallel to the longitudinal axis A (FIG. 5), thereby increasing the volume of cooling fluid capacity of groove 50. Thus, in FIG. 5, the upper ramped surface 54 and the lower ramped surface 56 extend non-orthogonal to each other and non-orthogonal to the longitudinal axis A.

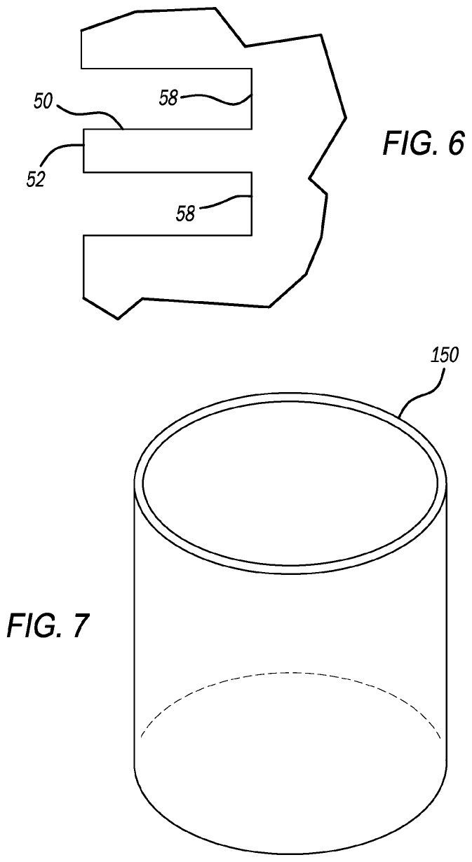

A groove base surface 58 (or groove inner surface) is at an innermost surface of the cooling groove 50. Thus, the groove base surface 58 is closest to the inner surface 26 of the receptacle 20. The groove base surface 58 is at an angle that approximates the slope of the inner surface 26 (FIG. 4), or can be parallel to the longitudinal axis A (FIG. 6). In the configuration of FIGS. 4 and 5, the groove 50 that is closest to the second end 14 has a greater slope than the higher grooves 50 because the inner surface 26 has a greater slope proximate to the second opening 24 in the example illustrated. The grooves 50 extend to different depths within the outer surface 52 so that the groove base surface 58 of the groove 50 remains equidistant from the inner surface 26 of the receptacle 20. For example and as illustrated in FIG. 4, the lowermost groove 50 extends the deepest (i.e., is the longest in cross-section) because the receptacle 20 is most narrow within the lowermost groove 50 proximate to the second opening 24. The groove base surface 58 also remains equidistant to the surface 26 as the groove 50 extends towards the second end. The distance between groove base 58 and inner surface 26 can be any suitable distance to maximize the heat transfer between the preform 110 and the cooling fluid, such as 2 mm to 4 mm, for example.

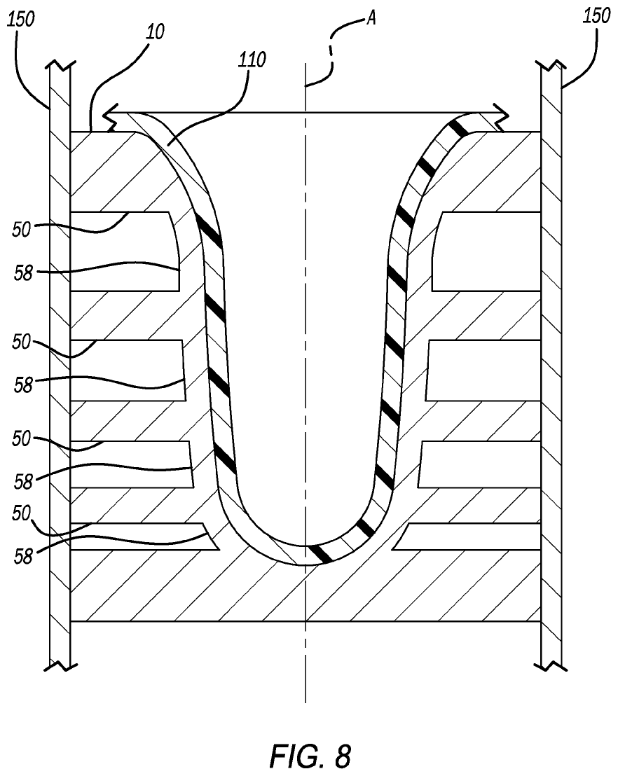

FIG. 8 illustrates another configuration of the cooling tube 10 in accordance with the present disclosure. The groove 50 may be configured to have a progressively decreasing height relative to the longitudinal axis A as the groove 50 extends from the upper end 12 to the lower end 14. Thus, areas of the groove 50 proximate to the upper end 12 are relatively taller as compared to areas of the groove 50 proximate to the lower end 14, with the height being measured in a direction parallel to the longitudinal axis A. In the configuration of FIG. 8, the depth of the groove 50 measured perpendicular to the longitudinal axis A increases in a direction from the first end 10 to the second end 14. Thus, the relatively taller portions of the groove 50 proximate to the first end 12 are relatively more shallow than the relatively shorter areas of the groove 50 proximate to the second end 14. In other words, portions of the groove 50 proximate to the first end 12 do not extend as far into the tube 10 in a direction perpendicular to the longitudinal axis A as compared to portions of the groove 50 proximate to the second end 14. As a result, the groove 50 has a relatively constant volume from the upper end 12 to the lower end 14.

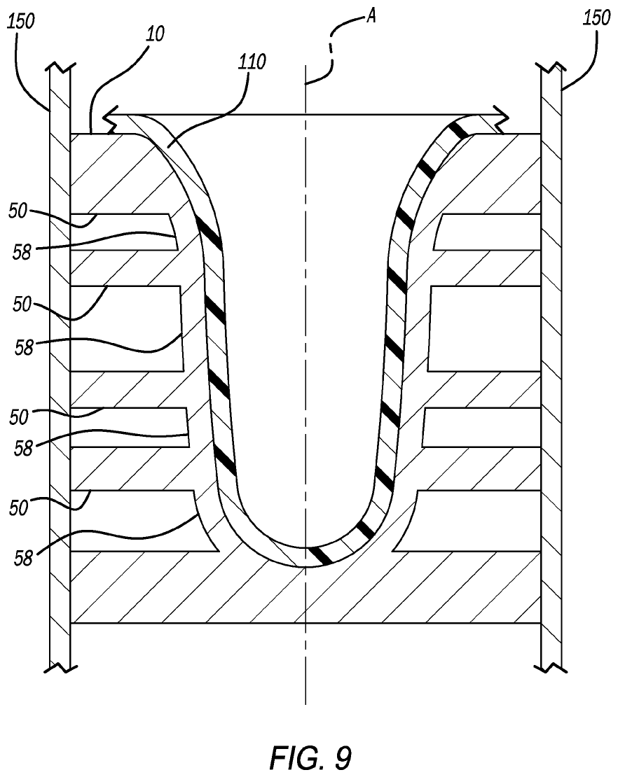

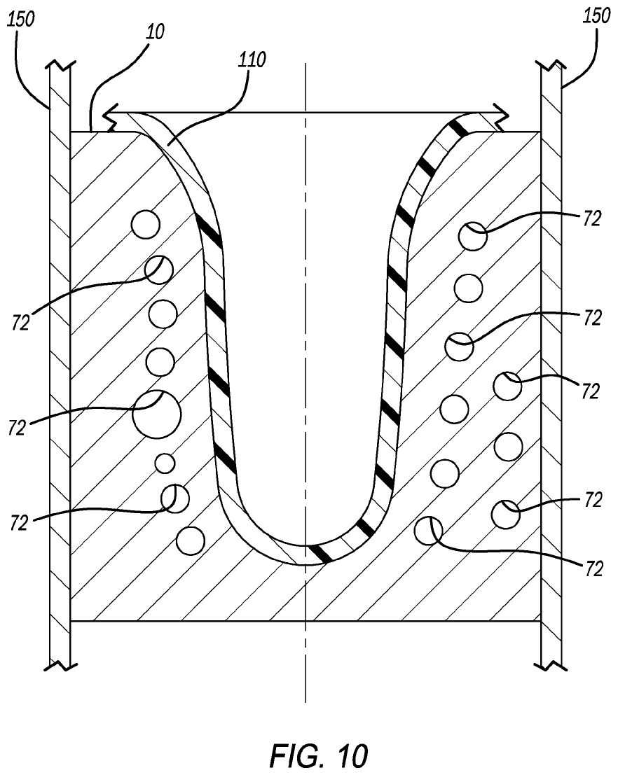

In the exemplary configuration of FIG. 9, the groove 50 of the cooling tube 10 can be configured to have areas of varying or alternating heights as measured in a direction parallel to the longitudinal axis A. The heights may be customized to expose more or less cooling fluid to different areas of the preform 110. With reference to FIG. 10, the cooling tube 10 may define a plurality of cooling channels 72 that wrap around the receptacle 20. The channels 72 may be formed in any suitable manner. For example, the cooling channels 72 may be formed by 3D printing of the cooling tube 10. The cooling channels 72 may also be formed by any suitable manufacturing process that incorporates high-powered lasers to melt metal powder, such as, but not limited to, the following: direct metal laser sintering (DMLS); selective laser melting (SLM); or direct metal laser melting (DMLM). The cooling tube 10 may be formed by any other material suitable for machining or DMLS, for example.

The cooling channels 72 may have any suitable diameter, and may have uniform or varying diameters. Any suitable number of multiple distinct channels 72 may be included, or only a single continuous channel 72 may be included. The channels 72 may have any suitable cross-sectional shape, such as, but not limited to, one or more of the following shapes: circular; square; diamond; triangular; oval; hexagonal; polygonal; etc.

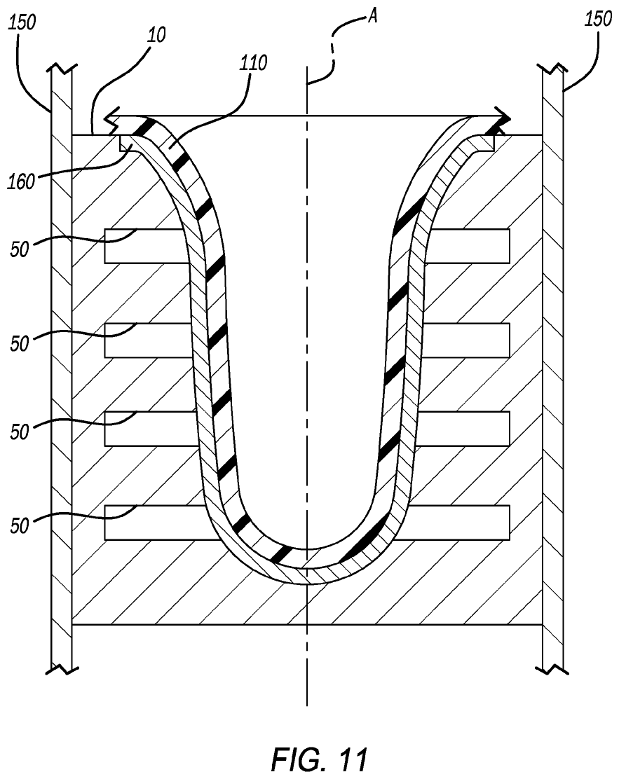

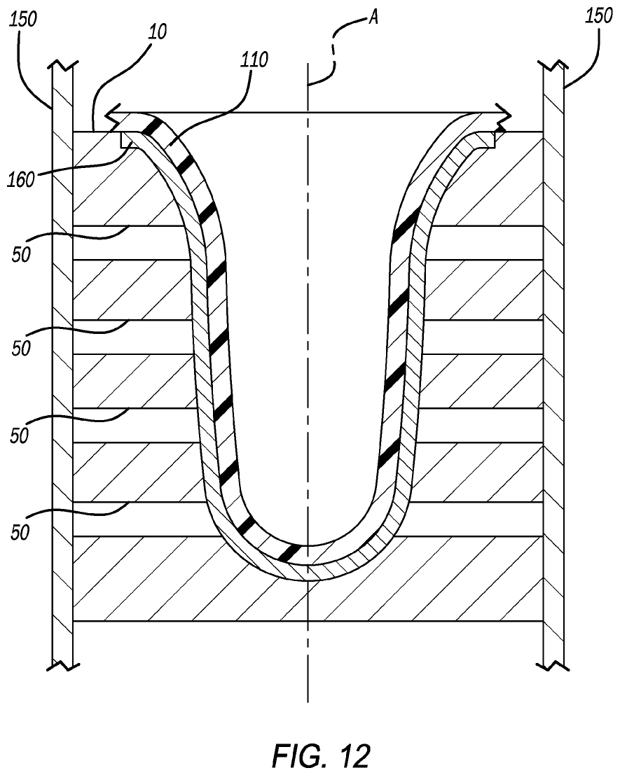

With reference to FIG. 11, the cooling groove 50 may be formed inward from the receptacle 20 and covered by an inner sleeve 160. The groove 50 stops short of the outer surface 52. In the configuration of FIG. 12, the groove 50 extends from the receptacle 20 to the outer surface 52. At the receptacle 20 is the inner sleeve 160. At the outer surface 52 is the outer sleeve 150.

The grooves 50 are configured to receive any suitable coolant therein (such as water, for example), and circulate the coolant around the receptacle 20 to cool the preform when the preform is seated within the receptacle 20. The grooves 50 are continuous, with an opening at an uppermost one of the grooves 50. At the opening is a pointed edge 70 (FIGS. 1-3). The pointed edge 70 facilitates introduction of coolant into the grooves 50 by reducing resistance and turbulence of the coolant at the entry point to the grooves 50. The grooves 50 may be configured, and the overall cooling tube 10 may be configured, such that flow of the coolant through the grooves 50 is turbulent or laminar.

The grooves 50 terminate at an outlet 80. The outlet 80 is in fluid communication with a lowermost one of the grooves 50 that is proximate to the second end 14. The outlet 80 extends from the lowermost groove 50 to the second end 14 to direct coolant out of the grooves 50.

The grooves 50 may have any suitable height at base surface 58 between surfaces 54 and 56, such as 4 mm, for example. The grooves 50 may have any suitable depth that corresponds to the taper of inner surface 26. The grooves 50 may be spaced apart at any suitable vertical interval measured at outer surface 52. For example, the grooves 50 may be spaced apart at 6 mm. The grooves 50 may thus have a height/spacing ratio of 2:3. The grooves 50 may have any suitable helical pitch angle range, such as 5 to 10 degrees. A suitable helical pitch is 8.4 degrees, for example. The grooves 50 may extend about the cooling tube 10 any suitable number of times, such as 4-6 times. The grooves 50 are configured to accommodate any suitable total volume of cooling fluid. The total volume will depend on the shape of the preform.

The grooves 50 are configured to accommodate cooling fluid moving at any suitable velocity. For example, the velocity may be dependent on the water chiller motor manufacturer, which is different from robot to robot. An exemplary velocity may be 4 mm/s, for example. The surface area of the grooves 50 are configured for increased optimal cooling of the preform. The grooves 50 may have any suitable diameter at outer surface 52, such as 68 mm, for example.

The grooves 50 provide numerous advantages. For example, the grooves 50 reduce mold cooling time and robot cooling time. As a result of using the cooling tube 10, a 20% or greater improvement in production capacity can be realized by reducing preform cooling time. A 15% or more weight reduction for the cooling tube 10 is also achieved, which allows robotic arm tooling to operate faster with less stress and wear. The present disclosure improves cooling by forming the cooling tube grooves 50 deeper into the tube 10 at varying depths to conform to the shape of the preform allowing better cooling through thermal transfer, allowing as much as four times more cooling fluid to circulate. Another advantage is the sharp entry point 70 of the groove 50, which reduces resistance and turbulence of coolant entering the groove 50.

After the preform is cooled in the cooling tube 10, a machine (not illustrated) places the preform heated to a temperature between approximately 190° F. to 250° F. (approximately 88° C. to 121° C.) into a mold cavity (not illustrated) having a shape similar to the final plastic container. The mold cavity is heated to a temperature between approximately 250° F. to 350° F. (approximately 121° C. to 177° C.). A stretch rod apparatus (not illustrated) stretches or extends the heated preform within the mold cavity to a length approximately that of the container thereby molecularly orienting the polyester material in an axial direction. While the stretch rod extends the preform, air having a pressure between 300 PSI to 600 PSI (2.07 MPa to 4.14 MPa) assists in extending the preform in the axial direction and in expanding the preform in a circumferential or hoop direction thereby substantially conforming the polyester material to the shape of the mold cavity and further molecularly orienting the polyester material in a direction generally perpendicular to the axial direction, thus establishing the biaxial molecular orientation of the polyester material in most of the container.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A cooling tube for cooling a preform configured to be injection blow-molded into a container, the cooling tube comprising:
a first end;
a second end opposite to the first end;
a receptacle within the cooling tube configured to receive the preform therein;
a first opening of the receptacle at the first end; and
a groove extending helically around an exterior of the cooling tube, the groove progressively increases in depth as the groove extends towards the second end, the groove configured to receive a coolant therein.

2. The cooling tube of claim 1, wherein the groove is defined by an upper surface, a lower surface, and an inner surface.

3. The cooling tube of claim 2, wherein the upper surface and the lower surface extend parallel to each other and extend perpendicular to a longitudinal axis of the cooling tube.

4. The cooling tube of claim 2, wherein the upper surface and the lower surface extend non-orthogonal to each other and non-orthogonal to a longitudinal axis of the cooling tube.

5. The cooling tube of claim 2, wherein the inner surface extends parallel to a longitudinal axis of the cooling tube.

6. The cooling tube of claim 2, wherein the inner surface extends parallel to an inner surface of the receptacle.

7. The cooling tube of claim 1, wherein the groove extends 4-6 times around the cooling tube.

8. The cooling tube of claim 1, wherein the groove has a pitch angle of 5 to 10 degrees.

9. The cooling tube of claim 1, wherein the groove is configured receive a coolant fluid.

10. The cooling tube of claim 1, the cooling tube further comprising a second opening of the receptacle opposite to the first opening.

11. The cooling tube of claim 10, further comprising a channel extending from the second opening to the second end of the cooling tube.

12. The cooling tube of claim 1, wherein the groove progressively increases in volume as the groove extends towards the second end.

13. The cooling tube of claim 1, further comprising an outlet defined at an end of the groove proximate to the second end, the outlet extending from the groove to the second end.

14. The cooling tube of claim 1, wherein the receptacle is configured to receive the preform configured to form the container configured as a wide-mouth container, and the receptacle is configured to be seated within a sleeve during cooling.

15. The cooling tube of claim 1, wherein the groove is configured to receive coolant traveling at about 4 mm/s.

16. The cooling tube of claim 1, wherein adjacent to an inlet of the groove is a pointed edge configured to reduce turbulence of the coolant as the coolant enters the groove.

17. The cooling tube of claim 1, wherein the groove progressively decreases in height from the first end to the second end.

18. The cooling tube of claim 1, wherein the groove alternates between relatively tall areas and relatively short areas as the groove extends from the first end to the second end.

19. The cooling tube of claim 1, wherein a height of the groove transitions between relatively tall areas and relatively short areas as the groove extends from the first end to the second end.

20. The cooling tube of claim 1, wherein the groove has at least one of the following cross-sectional shapes: circular; square; diamond; triangular; oval; hexagonal; and polygonal.

21. The cooling tube of claim 1, wherein the groove extends inward from the receptacle, and an inner sleeve is arranged over an opening to the groove at the receptacle.

22. The cooling tube of claim 1, wherein the groove extends inward from the receptacle to an outer surface of the cooling tube, the groove defining inner openings at the receptacle covered by an inner sleeve and outer openings at the outer surface covered by an outer sleeve.

23. A cooling tube for cooling a preform configured to be injection blow-molded into a container, the cooling tube comprising:
a first end;
a second end opposite to the first end;
a receptacle within the cooling tube configured to receive the preform therein, the receptacle including an inner surface shaped to correspond to a preform shape of the preform;
a first opening of the receptacle at the first end;
a second opening of the receptacle opposite to the first opening;
a channel extending from the second opening to the second end of the cooling tube;
a groove extending helically around an exterior of the cooling tube, the groove progressively increases in both depth and volume as the groove extends towards the second end, the groove configured to receive a coolant therein;
a base surface of the groove is sloped to match the inner surface of the receptacle;
a pointed edge at an inlet of groove, the pointed edge configured to reduce turbulence of the coolant as the coolant enters the groove; and
an outlet defined at an end of the groove, the outlet extending from the groove to the second end.

24. The cooling tube of claim 23, wherein the base surface of the groove remains equidistant to the inner surface of the receptacle as the groove extends towards the second end.

25. The cooling tube of claim 23, wherein the groove extends 4-6 times around the cooling tube.

26. The cooling tube of claim 23, wherein the receptacle tapers inward from the first end towards the second end.

27. The cooling tube of claim 23, wherein the groove is defined by an upper surface, a lower surface, and the base surface.

28. The cooling tube of claim 27, wherein the upper surface and the lower surface extend parallel to each other and extend perpendicular to a longitudinal axis of the cooling tube.

29. The cooling tube of claim 27, wherein the upper surface and the lower surface extend non-orthogonal to each other and non-orthogonal to a longitudinal axis of the cooling tube.

30. The cooling tube of claim 27, wherein the receptacle is configured to receive the preform configured to form the container configured as a wide-mouth container, and the receptacle is configured to be seated within a sleeve during cooling.
